(19) United States
(12) Patent Application Publication
(10) Pub. No.: US 2008/0268418 A1
(43) Pub. Date: Oct. 30, 2008

(54) VIRTUAL EDUCATION SYSTEM AND METHOD OF INSTRUCTION

(76) Inventors: John H. Tashner, Blowing Rock, NC (US); Richard E. Riedl, Boone, NC (US); Stephen C. Bronack, Raleigh, NC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/739,866

(22) Filed: Apr. 25, 2007

(51) Int. Cl. G09B 19/00; G06F 3/00; G06F 3/048

(52) U.S. Cl. 434/365; 715/706; 715/757; 715/758

(57) ABSTRACT

A computer-implemented method provides an educational environment in a virtual reality setting. Individuals navigate a virtual reality campus by using an avatar to interact with other users and to engage in learning experiences in the virtual setting. Individuals complete projects in virtual reality by accessing educational materials in electronic format and communicating with one another via text-based chats and real time audio. The virtual reality campus emulates a physical campus by providing meeting spaces and work areas where students spontaneously share information and complete pre-planned tasks. An electronic database tracks biographical and educational information about each user, that user's progress in achieving study goals, and the deliverables that the student produces to fulfill requirements of virtual instruction. The database also links to other systems, such as a registration database, so that the student's entire learning experience on both a physical campus and in virtual reality can be conveniently accessed electronically.

### BACKGROUND

The invention is a computer product that implements a virtual education system and a peer-based method of instructing students. The educational system utilizes a three-dimensional (“3-D”) social environment in which students, instructors, and administrators interact within a virtual campus over a computer network. The students achieve preplanned educational goals by participating in online learning experiences within the virtual campus. The faculty tracks and evaluates students' activities and required interactions to guide students toward realization of the educational goals. The system administrators provide the computer functionality, especially database services, to monitor the effectiveness of the virtual learning environment.

Society has evolved to a point where individuals are equally comfortable communicating via computer or in person. The demands of the busier and more mobile culture in which individuals interact today require familiarity with electronic systems and platforms. As such, educational systems increasingly rely upon electronic communications to complete certain tasks within a course of study. There have been numerous opportunities for students to complete distance-based and online courses in an electronic environment for a number of years. Computer products such as the Blackboard Academic Suite® and WebCT® have historically provided electronic educational services in web-based applications.

Previous electronic educational services, however, have continued to rely upon a top-down structure in which educators placed content in an electronic space that students could access. Even the advent of email and text-based chatting did not change the traditional format of these prior electronic systems in which the educational content was basically a substitute for sitting in a classroom listening to a lecture. None of the available web-based educational experiences allowed students to form small groups for sharing workspaces and assignments. Also, there were few opportunities for real-time, simultaneous discussions among all participants or subsets of participants using the system at any given time. The prior programs offered threaded discussion boards in which users listed comments one after the other. These threads were available for anyone to see and were often cumbersome when one tried to glean useful information from the thread. Blackboard® and WebCT®, along with similar programs Moodle® and Sakai®, have included text chat functions, but they offered only limited opportunities for unplanned synchronous interaction. Students and teachers had to set up a time to meet in the chat area. In this environment, it has been difficult for electronic classrooms to provide an educational experience that is anywhere close to an actual experience on a physical campus.

One of the most dramatic influences on the structure of electronic education systems has been the proliferation of gaming devices that have captured so much attention of late. Modern electronic games give the players a sense of “presence” in a world that is different from their own reality. The game participants take on an identity within the game and operate inside a virtual 3D environment. This type of stimulation has led to numerous individuals participating in virtual settings at every opportunity. As a result, there are multiple resources available for individuals to learn more about virtual reality settings and even create their own virtual reality programs.

One company that offers in-depth access to virtual reality programs is known as Activeworlds®, Inc. According to their website, “the Active Worlds Universe is a community of hundreds of thousands of users that chat and build 3D virtual reality environments in millions of square kilometers of virtual territory.” Obviously, a large segment of the population has come to expect access to virtual reality settings as part of their every day life. This explains the success of virtual reality programs like Second Life® and Sims Online®, which offer users the ability to take on a persona within a virtual reality world to play games, interact with other players, or even buy property in a virtual geography.

The proliferation of virtual reality systems has actually accomplished little to correct limitations in communication structures among students in an electronic educational setting, however. These prior electronic, or virtual reality, systems allowed users to talk to all users or just one other user, but the systems lacked any ability to facilitate groups or communities within the overall population on the system.

Small group experiences and learning opportunities among selected peers are the hallmarks of true-to-life student experiences in a campus setting. One other feature of a physical campus that has been lacking in electronic education is that of learning by merely being around other students and engaging in impromptu discourse. Students tend to stroll about a physical campus, and even when engaging in a casual period of “hanging out” with friends, opportunities arise to discuss each other's course work, their readings, and other meaningful topics. Just being present on a campus leads to serendipitous learning opportunities.

Without these types of small group interactions, the electronic educational systems (e.g., web-based or online courses) could not fully emulate a real-world campus setting. As a result, the quality of the education available in electronic classrooms or online suffered. The inventors herein, then, have identified a need to promote these impromptu or serendipitous learning opportunities within a virtual campus so that electronic or online experiences are better simulations of a physical campus.

Prior efforts to provide virtual realty educational systems have been shown in patent literature. For example, U.S. Pat. No. 6,226,669 (Huang, 2001) et al. discloses a multi-user virtual reality interaction system that is accessible via the world-wide web. Huang mentions (col. 11, line 57) that one example of a multiple-participant 3D virtual reality environment has been used at Tamkang University in Taiwan. Huang shows that all users can enter a virtual reality version of the Tamkang campus and interact with one another by chatting at will. Huang, therefore, focuses mainly upon allowing simultaneous, real time communications instead of providing a higher quality educational experience in the virtual campus.

Along the same lines as the Huang patent, European Patent Application No. EP1689143 (Nez, 2006) shows another improvement in communications within a virtual reality setting. The Nez '143 publication provides a system of communications between virtual reality participants, referred to therein as automats or smart agents. The Nez system allows these participants to interact in groups via public or private conversations over the internet. An agent can send a message to its group or to any number of other agents via text, voice, or video data. The Nez system formats the message for faster and more accurate reception by the intended user on the other end. Although Nez mentions that the communications system may be used in any number of settings, Nez offers no details on how such communication systems would benefit an educational experience.

The invention herein meets a need in the educational arena for electronics-based instruction that still provides a social context for learning by allowing more flexible communications among students, educators, and administrators.

### BRIEF SUMMARY OF THE INVENTION

The invention is a computer program product, computerized system, and computer-implemented method of providing an educational environment in a virtual reality setting. Individuals, including students, faculty, and administrators navigate the campus by using a graphical representation of themselves, known as an avatar, to interact with other users and to engage in learning experiences available in the virtual setting. Individuals complete pre-planned projects and assignments in virtual reality by accessing educational materials in electronic format and communicating with one another via text-based chats and real time audio.

The system and method described herein also encourages serendipitous learning by encouraging users to explore the virtual campus at will and make the most of opportunities to engage other system users. In this way, the virtual reality campus emulates a physical campus by providing meeting spaces and work areas where students spontaneously share information whether assigned to do so or not.

System users' progress within the campus is tracked and maintained in electronic format, most preferably by linking the virtual reality campus to a database. The database include biographical and educational information about each user, that user's progress in achieving goals of a course of study, and the deliverables that the student produces to fulfill requirements of virtual instruction. The database may also link to other systems, such as a registration database so that the student's entire learning experience on a physical campus and in virtual reality can be conveniently accessed electronically.

The method of teaching in a virtual campus allows for more in-depth experiences in an electronic education by giving students and faculty more freedom in designing and completing assignments. The virtual campus is accessible by any number of students in multiple physical locations, yet the navigation in virtual reality brings all the users together to achieve common goals. Accordingly, the method herein encourages cross-collaboration among students from different walks of life, different courses of study, and different peer groups on campus.

### BRIEF DESCRIPTION OF THE DRAWINGS

FIG. 1 is a screen shot of an entry point of a virtual reality campus according to this invention.

FIG. 2 is a screen shot of virtual reality buildings in the commons area of a virtual reality campus according to this invention.

FIG. 3 is a screen shot of the inside of a student services building in a virtual reality campus according to this invention.

FIG. 4 is a screen shot showing links available from administrative divisions of a virtual reality campus according to this invention.

FIG. 5 is a screen shot showing additional links to one educational department in a virtual reality campus according to this invention.

FIG. 6 is an illustration of an area within a virtual reality campus according to this invention by which a student accesses multiple electronic resources for educational purposes.

FIG. 7 is a link to blog sites by which visitors to the virtual reality campus of this invention engage in synchronous and asynchronous discourse regarding topics of interest.

FIG. 8 is an illustration of an area within a virtual campus providing links to specialized resources available in other regions of the campus.

FIG. 9 is an illustration of a metaphoric saloon in a frontier area of a virtual campus where system users meet and engage in educational experiences.

FIG. 10 is a flowchart of the overall teaching method implemented within the virtual campus of this invention.

FIG. 11 is an illustration of a student database record linked to the virtual campus of this invention.

FIG. 12 is an illustration of a course database record linked to the virtual campus of this invention.

### DETAILED DESCRIPTION

The invention herein meets the needs of educators by providing a computer program product that creates a virtual representation (10) of an educational campus. In this virtual reality campus (10), students, faculty, and administrators can achieve a sense of virtual “presence” in a “world” that is different from a physical campus, yet allows surprisingly similar educational opportunities. The system described herein also allows users to sense a feeling of “co-presence” in that the users feel that they are “in world” (i.e. in the virtual world as opposed to the physical world) with others. The avatars in the virtual world have the ability to chat, either by text-based or audio messaging. In this way, one avatar can lead the other to different places in the virtual world.

In particular, the computer program product allows users to navigate the virtual campus (10) and encounter settings that one would expect on a physical campus. For instance, there are virtual buildings that house libraries, offices, meeting spaces, and other known structures that students have come to expect at school. By allowing users to speak to one another and work together in the virtual campus, the users achieve the sense of “presence” on campus that stimulates growth and positive interaction. These interactions promote serendipitous learning opportunities, as the educational experience is more peer-based among users instead of the traditional, lecture-based classroom experiences. In fact, the teachers and administrators maneuver the virtual campus in a way that makes them extremely approachable “in world,” thereby flattening relationships between faculty and students. By diminishing the traditional levels of authority that teachers exert over their students, the whole educational arena becomes more of a peer-based learning experience in the virtual campus.

### Overview

The attached Figures give a good overview of the way in which the computerized system of this invention is set up. A user, or visitor to the virtual world, selects an image known as an avatar (20) to navigate through a virtual campus (10). The avatar's traits can be adjusted at the user's will by utilizing a drop-down selection (12) on the virtual campus (10) menu. The selected avatar (20) appears on the user's screen from either a third person or first person perspective. By using the arrow keys on the keyboard, the avatar (20) navigates the virtual reality campus (10). In a preferred embodiment, the system is programmed so that a system-controlled avatar (20), or bot, greets those who enter the virtual world. This avatar (20) can lead the user to different places in the virtual world through artificial intelligence in the system.

The computer program product implements the system of this invention by providing drop down menus (12) from a tool bar (13) that is accessible to the user. The drop down menus (12) include, but are not limited to, “teleporting” options to quickly move from one part of the campus to another, various “views” for selecting the avatar's perspective, “options” for setting up the user's experience on the virtual campus, and other system controls available from a menu system that would be familiar to most system users.

The virtual campus (10) includes areas for walking around, buildings to visit, and places to conduct the business of education. In most ways, the campus is a graphical representation of a real school campus. A tab selection (15) alongside the user's screen allows the user to view how many other visitors are in a certain part of the campus. The tab also has options for teleporting to other regions of the campus, including AppEdTec, the Commons area, Aufbau (link to K-12 students), the Cybraria, and EdAdmin. These areas are only exemplary regions of a virtual campus (10) and are in no way limiting of the invention or the areas that may be created to implement the system described herein. The system may include many metaphorical campus scenes and work spaces for courses that do not represent a literal campus of buildings.

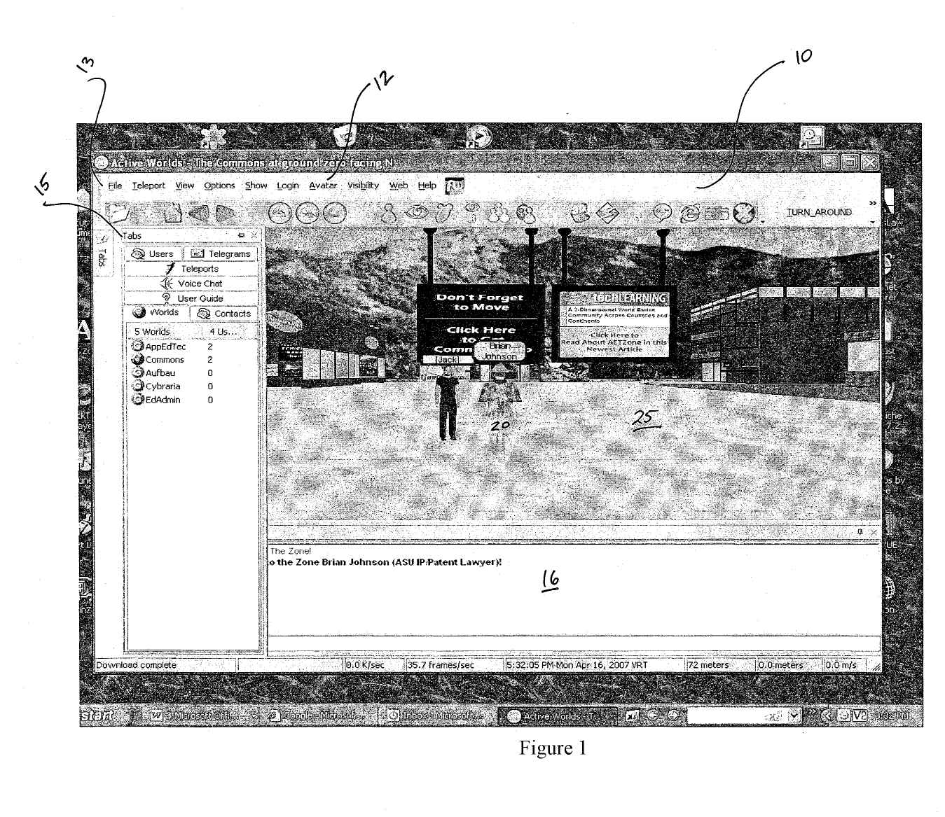

One useful component of the virtual system is its ability to implement various modes of communication between users. As shown in FIG. 1, the user may implement traditional text chats (16) with other users, or the users with appropriate hardware can use audio chat in real time.

As with any sophisticated software program, the invention herein includes a help section under the user tabs.

The most common starting point for the avatar (20) to maneuver through the campus is the Commons Area (25). From the Commons Area (25), there are multiple virtual buildings with different activity selections. For example, one building is the “Break Time Game House” with links to online games like sudoku, crosswords, and blackjack. “Chit Chats Coffee House” is set up for users to join in discussion links via text or audio chats with groups of users at tables. Other areas that students may enjoy linking include blogs, “wikis,” podcasts, streaming video, and small group shared work spaces. Otherwise, the system may encompass various team building experiences, online training, large virtual reality group meetings, seminars, and other forms of student interaction.

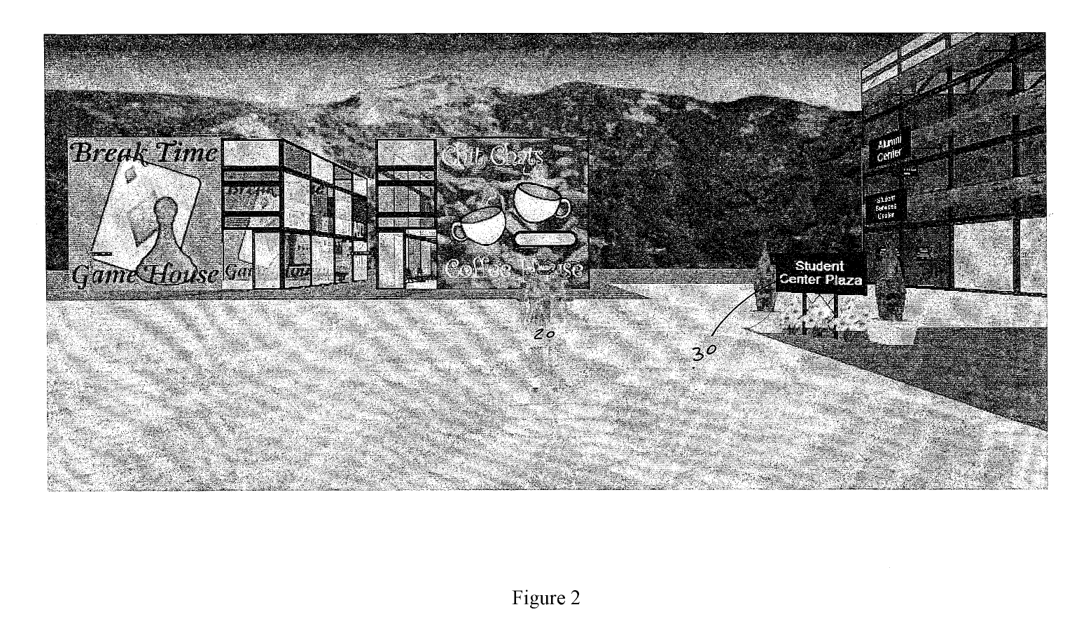

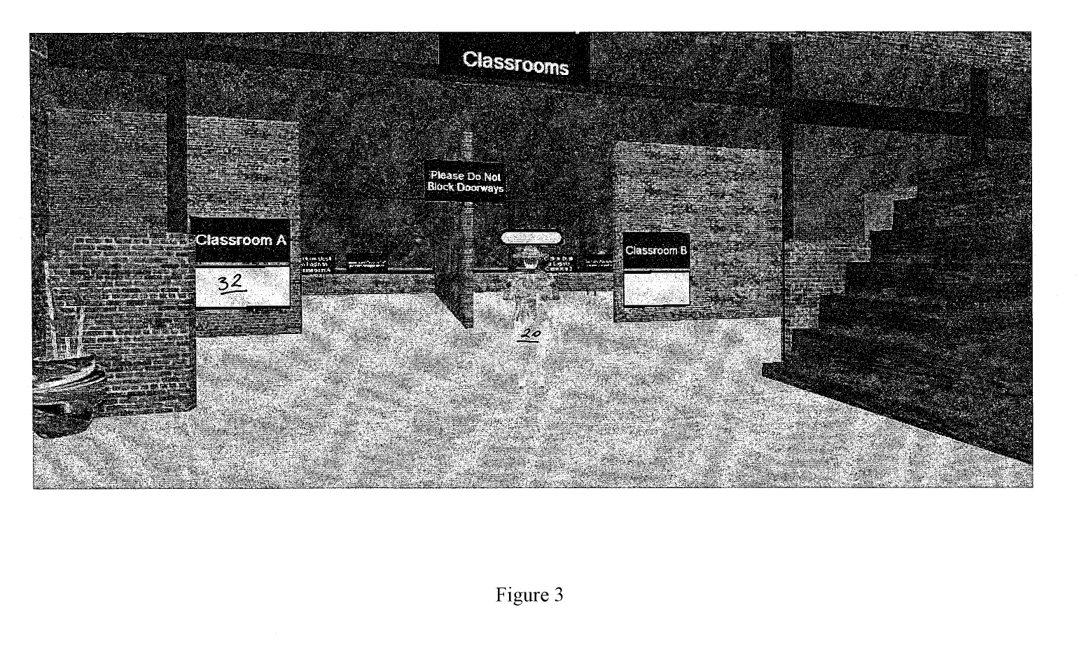

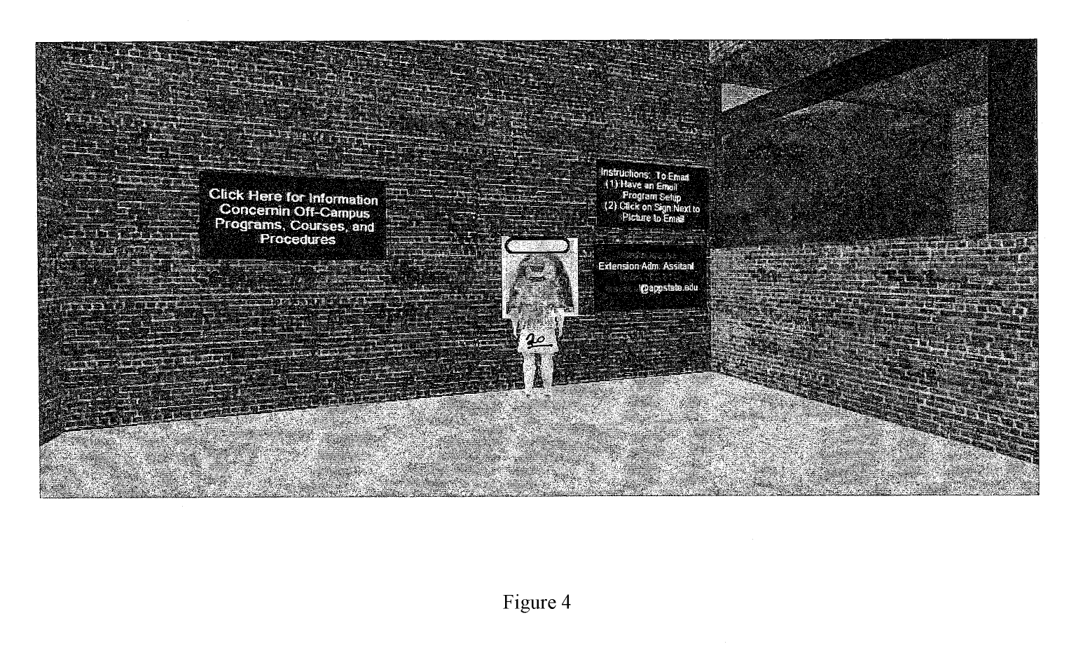

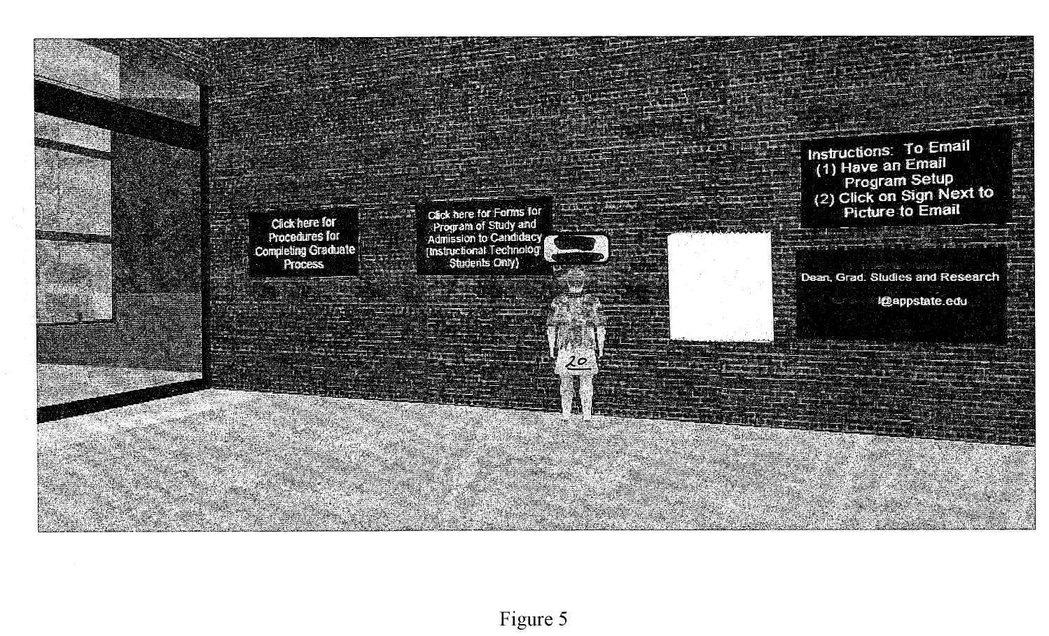

One other main area off the commons area is the Student Center Plaza (30). See FIG. 2. Within the Student Center Plaza (30), the avatar (20) can go into a classroom for online education. See FIG. 3. The avatar (20) also has options within the Student Center Plaza (30) to learn about courses available through distance learning (FIG. 4) and graduate studies (FIG. 5). The Student Center Plaza (30) also has significant administrative links to help students with paperwork and tasks that are part of their curriculum (e.g., gaining licensure to teach in certain areas).

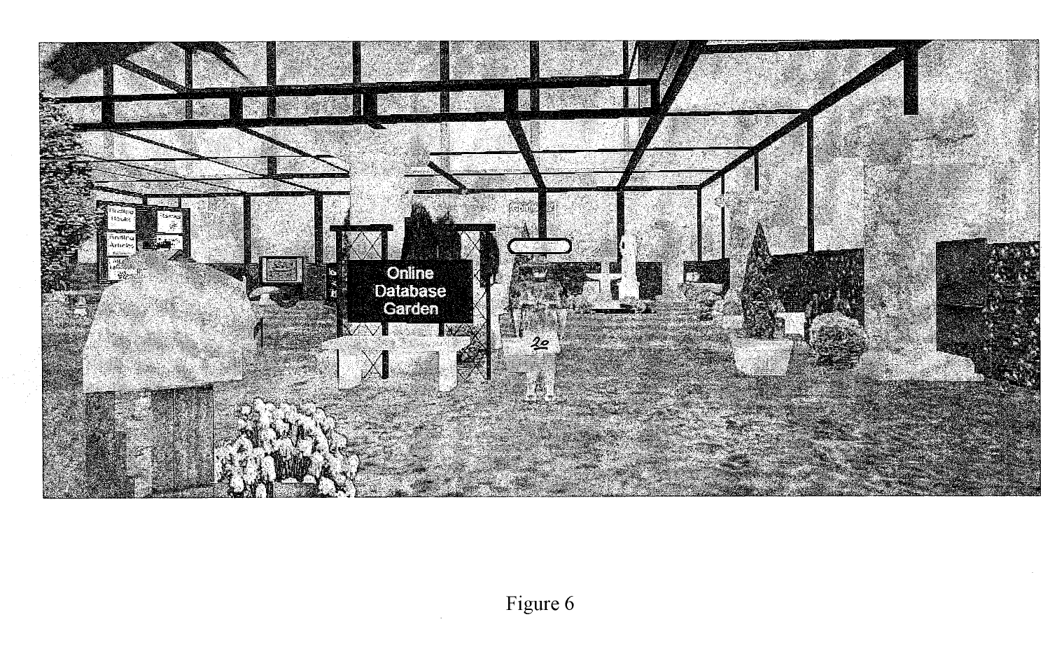

Outside the Student Center Plaza (20), the avatar has the option of entering the “Information Gardens.” The Information Gardens provides links to multiple sources of online information that a student will need to complete a preferred course of study. The Information Gardens include, but are not limited to, links to blogs, reading materials, online databases, pod casts, professional journals, text and voice chat librarian assistance, tutorials, literature reviews, bibliographies, and other research assistance. (FIG. 6). The Information Gardens, then, is a virtual representation of the university library. This is an example of the virtual world of the system described herein using a metaphor to represent a physical structure.

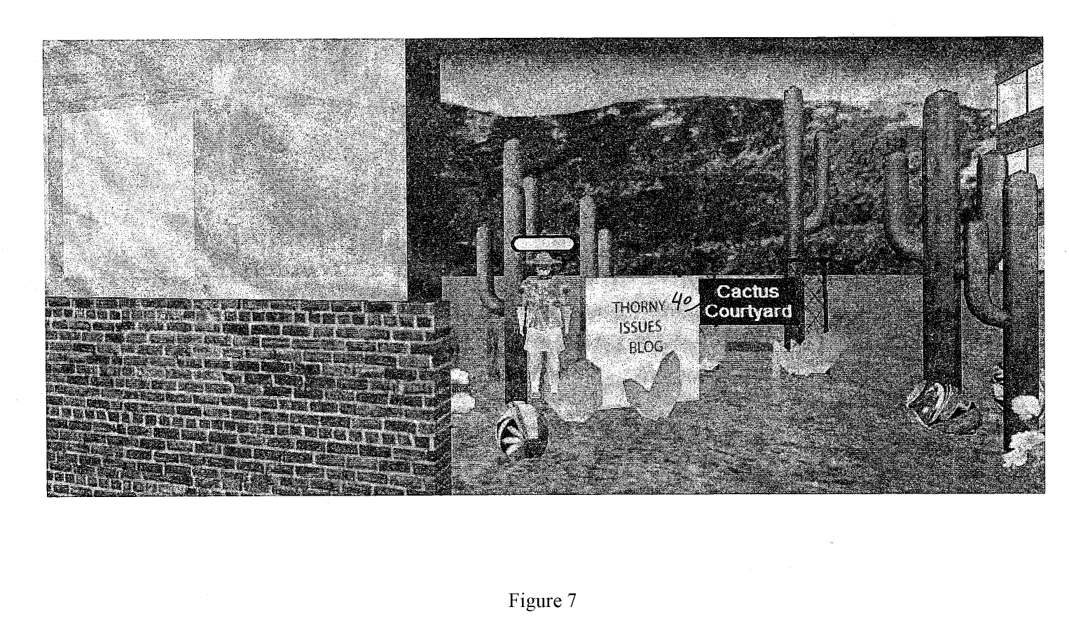

The system's use of metaphor is instrumental in designing areas in which students operate to maneuver the campus. An example of these metaphors is shown in FIG. 7, in which the avatar (20) has entered the “Cactus Courtyard” (40) area of the campus. The Cactus Courtyard (40) has a link to the “Thorny Issues Blog” where students can chat about topics of interest, usually those that provoke the most thought and strongest opinions. Many of the topics in the Thorny Issues Blog are based upon current journal articles in the field of study applicable to that user. Given the types of topics and lively discussions available in this region of the campus, the cactus metaphor is useful in highlighting the nature of the activities therein.

Other examples of metaphorical constructs are the various courses found in the virtual world. For a hypermedia course offered in the virtual world, the system uses the S-mart metaphor with mazes representing hypermedia. The system also includes a linear step by step construction for an advanced web design course, as opposed to the non-linear courses in which students have more freedom to choose the direction in which they explore and engage in course objectives and materials.

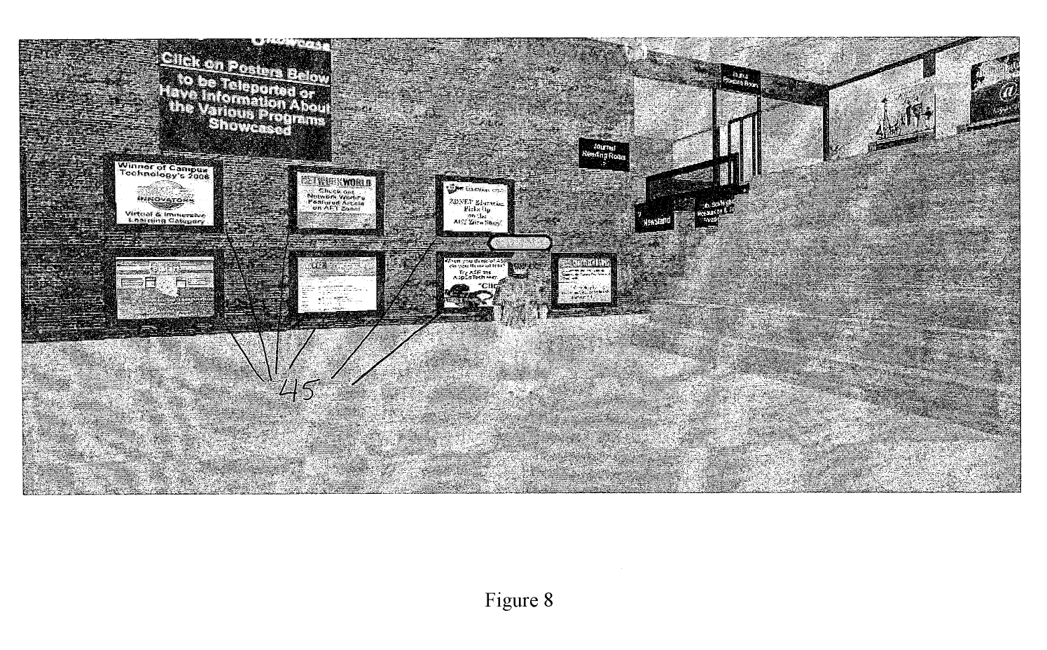

Other regions of the virtual campus provide extensive links to information that is both useful and required to complete a course of study “in world.” For example, one section of the campus is a storefront called “Spectacles” in which a student can click on numerous links (45) to participate in online educational experiences. See FIG. 8.

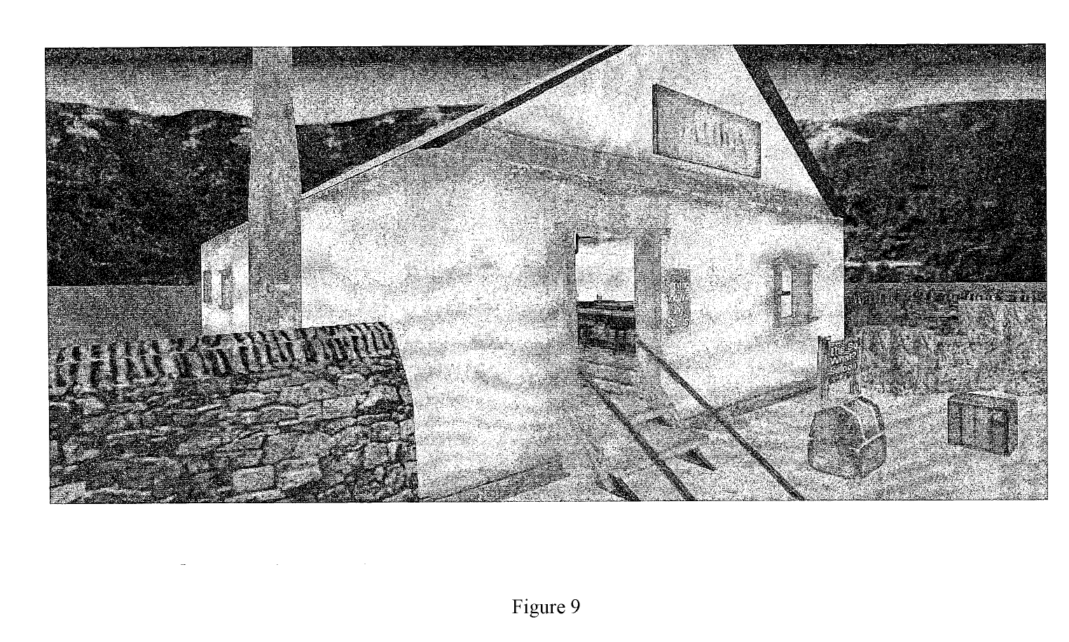

The Commons Area is just one example of a campus setting available in the virtual world of this invention. By using the tabs (15) available on one side of the screen, the avatar can immediately move to a different area, or “world,” called the “AET Zone.” Within the AET Zone, there is a teleport area that will allow the user to move into areas designated for educational courses. As discussed above, the courses of study available in this system often use metaphors to build the course area around a particular theme. For example, the course entitled FDN 5220 “Computers in Educational Settings” is designed around the Old West concept, given that computers in education bring forth many new frontiers for the users. As shown in FIG. 9, the Old West includes the “So What Saloon” to ponder questions that are relevant to the course. The idea behind the metaphor is to encourage users to strive for a vision of what computers can do in education and apply that vision to their coursework and careers.

The above-referenced areas of the virtual campus discussed herein are only examples of how a user can maneuver the virtual campus and encounter appropriate educational experiences therein. These examples are in no way limiting of the types of campus areas that can be developed to carry forward the purposes of the invention, described in more detail below.

### Technical Discussion

The invention is a computer program product that implements a teaching method via a computerized system in which students, faculty, and administrators operate in a virtual world. Individuals participating in this virtual setting utilize graphical 3D interfaces to socialize with one another, network to complete assignments, instruct each other, and complete requirements for courses of study. The system operates over a network, preferably the internet for wide availability, and allows multiple users to fulfill educational requirements in a virtual setting. In this way, the system implements a new pedagogical system and a new learning environment. In a preferred embodiment, the computer program product operates independently of any specific operating system or platform. One means of ensuring compatibility with a wider variety of systems is by implementing the system in JAVA, or some other cross-platform technology (e.g., the open source Croquet software).

During studies based on this virtual reality approach to teaching, educators have determined that “a 3D online learning environment, when used to enhance a Web-based course, can improve a student's interaction and discourse.” Jones & Bronack, Rethinking Cognition, Representations, and Processes in 3D Online Social Learning Environments, p.92(Idea Group, Inc. 2007). As noted in the Jones article, “[t]he 3D environment provides a temporary framework (scaffolding) for the user to integrate into existing cognitive strategies.” Id. at 95. “A learner in a 3D environment moves and interacts with the environment as an active participant, not as a viewer of a static scene. As an active participant, learners complete tasks that are helpful and useful, not forced and external. The tasks in which learners engage via situated activities are authentic—that is they emerge from naturally occurring interactions within the environment, rather than from neatly packaged and predictably embedded external prompts.” Id. at 96.

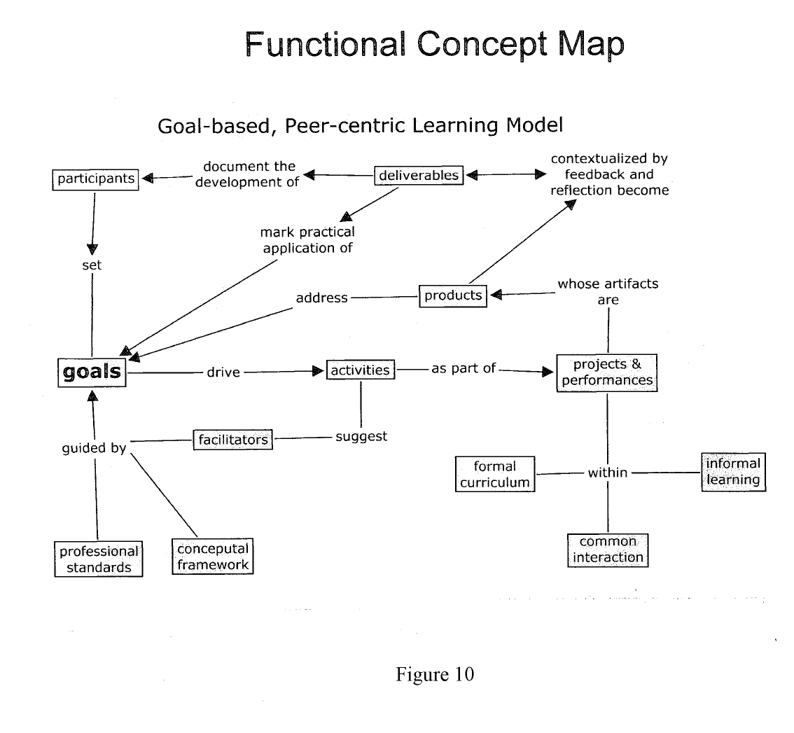

The computer program herein, then, implements educational experiences that take advantage of “situational learning” by encouraging interaction across traditional class, student, and faculty boundaries. In general, students are taught to take advantage of their own learning in the virtual world where learning is achieved predominantly by participating in social activity. The social networking environment utilized herein leads to peer-to-peer communications in a multimedia environment that breeds cross-collaboration among students, teachers, and administrators on the system. This functional concept is summarized in the flow chart of FIG. 10, which shows how information flows in a goal-based, peer-centric learning model.

The computer program product of this invention implements the learning model of FIG. 10 by providing certain educational tools over a distributed network to allow students an opportunity to complete pre-planned educational experiences in a virtual setting. The computer program product includes a computer readable storage medium having campus navigator commands thereon, preferably in the form of a drop-down menu or a tool bar (13). The navigator commands are executable by processors on servers and personal computers and generate a virtual reality campus (10) in which students, educators, and administrators interact. The software includes an avatar (20) generation sequence for creating an avatar (20) in the form of an animated representation of at least one student. Of course, multiple students can access the computer program at the same time. The software further includes a campus generation sequence for creating a mapped virtual campus (10) in which the avatar (20) moves and engages in educational experiences within the campus.

The virtual campus (10) of this invention is a 3-D representation of the campus that includes the traditional structures that a student would expect the physical campus. The virtual campus (10) houses an electronic library, student center, meeting spaces, bulletin boards for announcements, and even allows for vendors to offer products and services on campus. In one particularly useful embodiment, the system includes a movie theater in which multiple individuals are able to view the same or different presentations on their respective computers at the same time. So User No. 1 may watch a first presentation, and User No. 2 may start another presentation a few minutes later with both users viewing their preferred content.

To get started, a user selects the attributes of the representative avatar (20) from a drop-down menu (12). The avatars (20) are available for customization depending on the student's level of skill in manipulating the graphics of the virtual campus. The user can access keys on the traditional keyboard to move the avatar (20) from one location to another and to communicate with other avatars in the virtual campus. In a preferred embodiment, the avatars (20) communicate via audio links and text-based messaging links. Both audio and text based messaging may be implemented in “whisper” mode to control the extent to which comments are published to the group, i.e., small groups may communicate without others being involved. The communication abilities within this system allow for real-time and asynchronous messaging. The shared audio and presentation work spaces enable the system to offer speakers and seminars to address large groups of students at once.

Most of the options for controlling an avatar (20) on the virtual campus (10) are available from a drop-down menu also known as the dashboard. As noted above, the dashboard (12) allows students to move within the virtual campus (10).

The virtual campus (10) may be set up to include different “worlds” that have various functions. Certain worlds may be more student-activity based while others provide significant amounts of school administration opportunities. One particularly useful world in a preferred embodiment of this invention gives a student access to the courses that are offered at the physical university. This student can complete the requirements of a real course by using the avatar appropriately to fulfill course requirements in the virtual campus.

By linking the virtual campus (10) to real courses that would be offered in a physical campus, the method and system of this invention offer new teaching styles that do not rely on purely traditional relationships between faculty and students. The course requirements in a virtual course must be evaluated in the same manner by which a student would be graded in a normal classroom. To accomplish this evaluation process, the computer program product of this invention connects to a database for tracking each student's progress in regard to objectives of the course.

In applying these new teaching techniques available in a virtual world to courses of study that are practical and useful in a physical world, the administrators of the system herein create an assessment process that is student focused. Course requirements to be fulfilled in a virtual reality experience are based on the same standards that a teacher would apply in the physical classroom. In this way, the teacher can map activities for the students to engage and link these activities to the artifacts, or course deliverables, that the students must complete to get credit for the course. As in traditional classroom experiences, the virtual reality program allows for the generation of student achievement reports, course the effectiveness reports, and overall program accountability reports.

A database link to the virtual reality campus is extraordinarily useful to ensure that the students are participating, completing assignments, and learning the material at hand. Within the database, each student has a matrix based on the standards of the program. The students can access this matrix by navigating their respective avatar to the appropriate administrative area on the virtual campus. In one preferred embodiment, the students can assess the standards for a course and propose deliverables that would meet the appropriate objectives. The computer program product and system described herein give a student wide latitude in determining how to complete the course in a virtual reality setting in a way that is most suitable to that student. By accessing the same area in a virtual campus, teachers and administrators can guide students' progress by analyzing the students' proposed deliverables and suggesting means for completing those. By no means is a student left to complete a course of study unassisted. The teaching method used in the virtual reality campus allows the students to communicate electronically and interact in a virtual setting with as much freedom as possible and as much guidance as necessary.

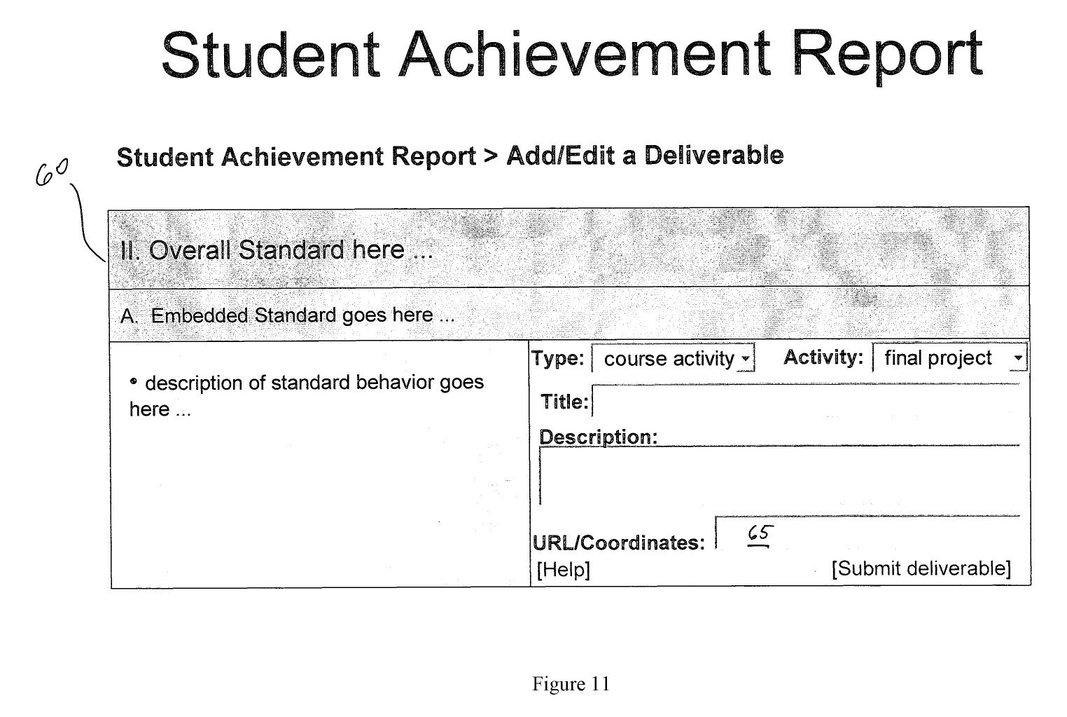

By linking database services to the virtual reality campus, the computer system described herein allows the school faculty and administration opportunities to guide students much as they would in a physical campus. For example, FIG. 11 shows a representative student achievement report for a course of study. This screen would serve as a starting point for students to manage their respective matrix. The deliverables section (60) links to the respective student's matrix. The goals section lets users plan their achievements for the course. The students maintain their own matrices by adding or editing deliverables within the database. Students select types of deliverables that will fulfill course objectives and provide a title, a brief description, and either the Web address or the geographical location (65) where this student will leave the deliverable on the virtual campus (10).

If the student chooses to leave the deliverable (60) at a specified location in the virtual campus, the system may allow certain other users access to that deliverable. Typically, at least a professor or faculty member will have access to the deliverable, and the deliverable will be listed as “under review” until approved by that reviewing faculty member. The system is sufficiently flexible to allow multiple faculty members to review and comment on the same deliverable, depending on the nature of the project.

The system may be configured to allow multiple levels of review by various system users. In a preferred embodiment of this system, deliverables that have been submitted are listed in the student's matrix. The database connected to the virtual reality campus (10) provides details on the deliverable, including a record of previous reviews and a listing of comments submitted by other users. Once the deliverable moves from “under review” to “approved,” the background color of that cell is changed to green for visual indication of completion.

The database functionality of the system herein may be connected to traditional computer programs used by a campus registrar on a physical campus. The database, therefore, can track student records including, but not limited to, student biographical information, course transcripts, and completion dates for various activities within the course of study. The database may be searched to show the academic results of individual students, a course group or section, or the history of any course that has been taught using the virtual reality campus.

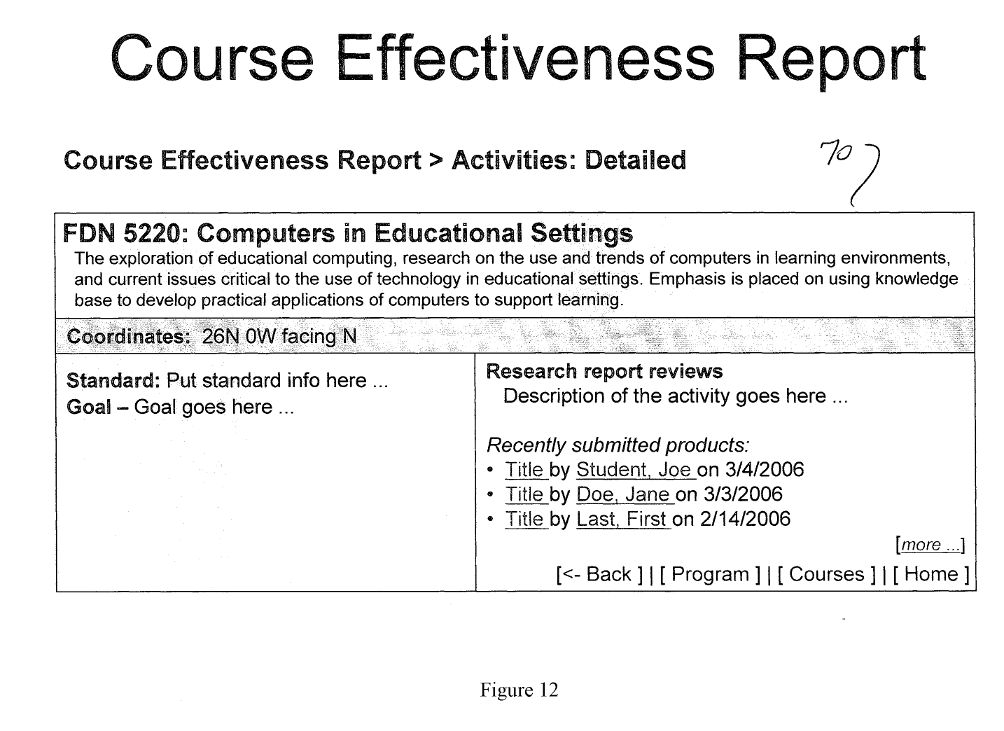

In a most preferred embodiment, the database actually maintains records of deliverables that the students have submitted in completing a course. As shown in FIG. 12, a course effectiveness report (70) lists the standards, the goals, and the submitted products associated with that course. This detailed review displays the course activities and a list of recently submitted artifacts addressing the activity. The title links to the product, or course deliverable, and the student name links to the matrix. The course effectiveness report also gives the coordinates of the location in the virtual reality geography at which the course deliverable may be found. In a different embodiment, the course effectiveness report lists the aggregate results from online course evaluation forms. Those with access to the forms may add reflection statements to accompany the evaluation results, thereby communicating more information to students who are interested in taking that course.

The database functionality of this system also allows for a program accountability report. The program accountability report provides data on the performance, alignment, and progress of program participants, courses, and activities. The various views within the database provide snapshot information of important data within that course, such as demographics and graduation rates. The database also provides a convenient means of collecting data from interviews and surveys that users may encounter in the virtual campus world.

The computerized method and system of this invention allow for new teaching methods because of the nature of electronic communications and the virtual reality campus. One method used herein is that of dividing students into groups known as “cohorts.” Cohorts may include certain segments of the virtual population that will proceed through the same course of study within the campus. Cohorts may be assigned by some objective criteria, such as date of matriculation or geographic proximity.

As the faculty creates assignments for a program within the campus, the assignments may include requirements that students form teams within a cohort, or the assignments might require the teams to include members from more than one cohort. Forming the teams becomes an exercise requiring interaction among citizens of the virtual world and promotes educational discourse among a diverse population.

Cohort activity is tracked within the database so that an individual student's matrix includes results of that student's participation in a small group. The idea behind using small group activity within a virtual community campus is to flatten relationships between teachers and students and have students interact as part of the learning experience. Of course, the cohorts can interact with one another using the text-based and audio communication functions of the product described herein.

One of the first assignments within the virtual reality classroom could be that of establishing a team having certain demographic qualities. In this way, the students have to navigate the campus and meet other students that are in the same course. The students get to know each other in the virtual setting, i.e., their avatars interact, and the students select peers in the virtual campus to be part of their group. The virtual reality campus, therefore, takes advantage of the electronic social networking that is prevalent among students today.

One useful feature of the virtual system is that each avatar may optionally show the student name above the graphical image of the avatar. In a most preferred embodiment, users can access biographical information about the student represented by any avatar. As noted above, the biographical information is maintained in the database connected to the virtual campus. In this way, the students know a little more about the avatar before choosing to work with that person. As shown in the figures herein, students usually have first and last names displayed above their avatar image, while teachers only have first names. This allows the citizens of the virtual campus to distinguish the identities and roles of other avatars on campus. The system also encompasses the technical capabilities for users to link to the database and learn more in-depth information about a particular avatar that the user encounters in the virtual reality world.

Once a team has been organized, the team gets a notebook (e.g. a virtual work space within the system) at a geographical location on the virtual reality campus. The team, therefore, will be able to access a shared workspace in the virtual world. The shared workspace allows simultaneous viewing of websites, documents, slide presentations, and other web conferencing functions. The team members have access to the notebook and the shared workspace for collaborative editing of deliverables. The system accounts for certain traditional checkpoints along the way in a course by providing means for students to give virtual world presentations to their classmates,

Students are not expected to be as immediately familiar with the virtual campus as they may be with a physical campus. One of the first assignments, therefore, within the virtual campus is to get to know the surrounding areas. The faculty may also assign tasks, such as meeting an avatar from a different course or a different section of the same course. The assignments, therefore, are geared to encourage discourse among students on a wide variety of topics by ensuring that their avatars bump into one another somewhere in the virtual geography. By communicating with other citizens in the virtual world, particularly peer groups, the student has more opportunities for serendipitous learning.

The virtual campus is particularly suited for interaction among users in different degree programs on a virtual campus or even among professionals in different fields. For example, cross-collaboration is possible when different skills are necessary to complete a bigger goal, e.g., projects that require educators, technology experts, administrators, and other specialties. The virtual campus of this invention includes a systematic way to organize each individual's deliverables, making discrete information available globally. By sharing information in the virtual campus and using a database infrastructure to track progress in multiple areas, teammates can share and interpret data as a group rather than just submitting one piece of the puzzle with no vision of the bigger picture at hand. The system encourages cross-collaboration among users from all different programs and walks of life. For instance, one feature allows the users to access time zone conversion software to assist in planning meetings “in world” when the users are in different time zones in the physical world.

One concept that may be implemented via this system is that of “augmented reality.” In this embodiment, teams or cohorts experience certain portions of the system in common. Other portions of the system are customized for that particular user. For example, each member of the team may be able to access a shared workspace and certain deliverables, electronic content, or other common information. As part of an assignment, however, individual users would also access user-specific information, or content, regarding a project so that the team as a whole would have to work together with common information and specific assignments to realize a goal. The individualized information would be available via clickable objects in the virtual world, and the database linked to that user would control the access rights for that user. Those access rights would determine the content that the particular user experienced in the virtual setting. This particularized content ability could lead to user-specific messaging, advertising, and other experiences in the virtual world.

The invention described herein can be used in multiple settings and not just a traditional educational environment. There are numerous applications to the virtual campus in corporate life as well as government, scientific research and development, or any venture that uses multimedia applications in its business. Those having skill in the art will recognize that the invention may be embodied in many different virtual reality scenarios. Accordingly, the invention is not limited to the particular programs illustrated herein.

In the drawings and specification there has been set forth a preferred embodiment of the invention, and although specific terms have been employed, they are used in a generic and descriptive sense only and not for purposes of limitation, the scope of the invention being defined in the claims.

1. A computer program product for use in a distributed network to provide educational experiences in a virtual setting, comprising:
a computer readable storage medium having campus navigator commands thereon, said campus navigator commands being executable by a processor and comprising:
an avatar generation sequence for creating an avatar in the form of an animated representation of at least one student;
a campus generation sequence for creating a mapped virtual campus in which said avatar moves and engages in educational experiences within said campus;
a database for tracking each student's progress in regard to objectives related to said educational experiences, said database accessible by and in electronic communication with said campus navigator commands.

2. A computer program product according to claim 1, wherein said virtual campus is experienced via a computer screen.

3. A computer program product according to claim 1, wherein said virtual campus is a 3D representation of an educational campus.

4. A computer program product according to claim 1, wherein said campus navigation commands comprise a utilities tab displayed on a computer screen with selectable options for interacting within the virtual campus.

5. A computer program product according to claim 1, wherein a user selects the attributes of an avatar from a drop down menu.

6. A computer program product according to claim 1, further comprising multiple avatars within said virtual campus.

7. A computer program product according to claim 6, wherein said multiple avatars interact.

8. A computer program product according to claim 7, wherein said multiple avatars interact in situational learning scenarios.

9. A computer program product according to claim 7, wherein said avatars interact by communication via audio links.

10. A computer program product according to claim 7, wherein said avatars interact by communication via text-based messaging links.

11. A computer program product according to claim 1, wherein said database tracks data regarding individual courses.

12. A computerized system accessible by multiple system users over a distributed network for providing a peer-based educational experience in a virtual setting, comprising:
a computer readable storage medium having campus navigator commands thereon, said campus navigator commands being executable by a processor and comprising:
an avatar generation sequence for creating an avatar in the form of an animated representation of at least one student;
a campus generation sequence for creating a mapped virtual campus in which said avatar operates;
at least one dashboard for controlling avatar movement through said virtual campus, said dashboard comprising selectable options for moving from one location to another;
a database for storing deliverables that students generate during an educational experience, said deliverables being accessible to another system user via said campus navigator commands.

13. A computerized system according to claim 12, wherein said campus comprises meeting spaces in which avatars communicate with one another.

14. A computerized system according to claim 12, wherein said meeting spaces are designed with a theme based on a metaphor related to the educational experience therein.

15. A computerized system according to claim 12, wherein said dashboard provides an option for teleporting from one campus location to another.

16. A computerized system according to claim 12, wherein said dashboard provides a link to an internet browser.

17. A computerized system according to claim 12, wherein said dashboard provides a link to a message board.

18. A computerized system according to claim 12, wherein said virtual campus comprises meeting spaces in which avatars communicate.

19. A computerized system according to claim 12, wherein said virtual campus provides links to communication tools selected from the group consisting of discussion boards, chat rooms, and announcement bulletins.

20. A computerized system according to claim 12, wherein said deliverables comprise homework assignments that system users submit for review by other users.

21. A computerized system according to claim 12, wherein said deliverables comprise written work product created by groups of users who collaborate on an assignment.

22. A computer implemented method of providing a virtual campus-based educational system for students within a commonly accessed network, the method comprising:
mapping the campus by providing computer displays for each respective location in the campus;
creating an avatar in the form of an animated representation of at least one student;
creating meeting spaces within the campus in which avatars encounter one another in virtual reality social situations and communicate with each other to achieve goals of the educational system; and
tracking students' interactions to monitor each respective student's progress in regard to the goals.

23. A computer implemented method according to claim 22, wherein the tracking step is performed by educators in a distance learning environment.

24. A computer implemented method according to claim 22, further comprising assigning the system users to groups that work together to achieve said educational goal.

25. A computer implemented method according to claim 22, wherein the step of assigning groups comprises the avatars meeting one another and inviting other avatar system users to join a specific group.

26. A computer implemented method according to claim 22, wherein the meeting spaces are equipped with audio-based messaging for avatar communication.

27. A computer implemented method according to claim 22, wherein the meeting spaces are equipped with text-based messaging for avatar communication.

28. A computer implemented method according to claim 22, wherein the mapped locations within the campus are selected from the group consisting of a library, a classroom, a student center, and an administrative office.

29. A computer implemented method according to claim 22, wherein the educational goals comprise course work in a distance learning environment.

30. A computer implemented method according to claim 22, wherein the educational goals comprise specified interactions among avatars.

31. A computer implemented method according to claim 22, wherein the pre-planned educational goals comprise reading assignments utilizing deliverables that are stored within the virtual campus.

32. A computer implemented method of providing a virtual campus-based educational system for students within a commonly accessed network, the method comprising:
mapping the campus by providing computer displays for each respective location in the campus, wherein the mapping comprises providing location coordinates in a virtual geography;
assigning avatars to individuals accessing the virtual campus;
creating spaces within the campus in which avatars access deliverables that are placed in respective campus locations for indexed retrieval.

33. A computer implemented method according to claim 32, further comprising the step of connecting the campus to a database that tracks an avatar's progress in creating the deliverables.

34. A computer implemented method according to claim 32, wherein the step of assigning avatars to individuals comprises registering an individual for a course within the campus.

35. A computer implemented method according to claim 34, wherein the step of registering the individual for a course comprises connecting the registration to the database for recording the individual's progress within the course.

36. A computer implemented method according to claim 32, further comprising the step of connecting the virtual campus to a database for storing the deliverables that students generate during an educational experience, the deliverables being accessible to another system user via campus navigator commands.

37. A computer implemented method according to claim 32, wherein the step of connecting the virtual campus to a database comprises linking an avatar in the virtual campus to a record in the database that stores biographical information about the user represented by each avatar.

38. A computer implemented method according to claim 37, further comprising the step of accessing biographical information about an avatar to determine the identity of the person represented by that avatar on the virtual campus.

39. A computer implemented method according to claim 32, wherein the individual accessing the virtual campus receives content that is specific to that individual.

40. A computer implemented method according to claim 32, wherein the individual accessing the virtual campus receives content that is available to all users at once.
